(19) United States
(12) Patent Application Publication
(10) Pub. No.: US 2026/0293930 A1
(43) Pub. Date: Oct. 1, 2026

(54) Stand mixer accessory for making ice cream

(71) Applicant: Dongguan Hongying Electrical Technology Co., Ltd., Dongguan City (CN)

(72) Inventor: Jiaying LIN, Dongguan City (CN)

(73) Assignee: Dongguan Hongying Electrical Technology Co., Ltd., Dongguan City (CN)

(21) Appl. No.: 19/210,952

(22) Filed: May 16, 2025

(30) Foreign Application Priority Data
Mar. 28, 2025 (CN) 2025205634488

(51) Int. Cl. A23G 9/12; A23G 9/22

(52) U.S. Cl. CPC A23G 9/12; A23G 9/222; A23G 9/224

(57) ABSTRACT

A stand mixer accessory for making ice cream, comprising a temperature storage barrel assembly, a stirring shaft component, a connecting barrel component, an ice shaver accessory and a transmission accessory; when the ice shaver accessory is connected to the connecting barrel component, an ice shaver input shaft of the ice shaver accessory can obtain power from a secondary output shaft of a stand mixer, and the stirring shaft component is linked to rotate in the temperature storage barrel assembly through the ice shaver output shaft; when the transmission accessory is connected to the connecting barrel component, a transmission input shaft of the transmission accessory can obtain power from the secondary output shaft of the stand mixer, and the stirring shaft component is linked to rotate in the temperature storage barrel assembly through a transmission output shaft.

### CROSS-REFERENCE

This application claims the benefit of priority from China Patent Application No. CN 2025205634488 filed on Mar. 28 2025, the contents of which are hereby incorporated by reference in their entirety.

### TECHNICAL FIELD

The present invention relates to the technical field of household electrical appliances, in particular to a stand mixer accessory for making ice cream.

### BACKGROUND TECHNOLOGY

A stand mixer (also known as a “food processor” or “cooking machine”) is a commonly used household appliance or commercial appliance. The stand mixer is equipped with a main output shaft and by attaching different accessories to this shaft (such as various types of mixing blades, meat grinders, etc.), it can perform operations like kneading, mixing, and grinding meat.

Making ice cream is also one of the common uses of a stand mixer. Specifically, a temperature storage barrel needs to be configured on the bowl of the stand mixer (the interlayer of the temperature storage barrel contains a temperature storage material. After the temperature storage barrel is frozen, the liquid falling into the temperature storage barrel can be cooled until it frosts). The liquid in the temperature storage barrel is stirred by a stirring shaft with a specific structure on the stand mixer, so that the liquid continuously adheres to the inner wall of the temperature storage barrel and exchanges heat with the temperature storage barrel until the liquid in the temperature storage barrel frosts and forms ice cream.

Before making ice cream, a stand mixer in the prior art needs to install a temperature storage barrel on the bowl of the stand mixer and install a stirring shaft with a specific structure on the main output shaft of the stand mixer; when making ice cream, the bowl and main output shaft of the stand mixer need to be occupied, and the stand mixer cannot be used for other operations; after making ice cream, the temperature storage barrel needs to be removed from the bowl of the stand mixer and the stirring shaft needs to be removed from the main output shaft of the stand mixer.

The above process will obviously consume much time and energy. Therefore, how to provide an efficient and simple ice cream making device for a stand mixer has become one of the problems to be solved urgently.

### SUMMARY OF THE INVENTION

The purpose of the present invention is to provide a stand mixer accessory for making ice cream, which can provide an efficient and simple ice cream making device for the stand mixer.

To achieve the above purpose, the present invention provides following technical solutions: a stand mixer accessory for making ice cream, comprising a temperature storage barrel assembly, a stirring shaft component, a connecting barrel component, an ice shaver accessory and a transmission accessory, wherein the ice shaver accessory comprises an ice shaver input shaft suitable for connecting to a secondary output shaft of a stand mixer, and an ice shaver output shaft drivingly connected to the ice shaver input shaft; the transmission accessory comprises a transmission input shaft suitable for connecting to the secondary output shaft of the stand mixer, and a transmission output shaft drivingly connected to the transmission input shaft; the connecting barrel component covers the temperature storage barrel assembly, and the ice shaver accessory and the transmission accessory are connected to the connecting barrel component interchangeably; when the ice shaver accessory is connected to the connecting barrel component, the ice shaver input shaft of the ice shaver accessory obtains power from the secondary output shaft of the stand mixer, and drives the stirring shaft component to rotate in the temperature storage barrel assembly through the ice shaver output shaft; and when the transmission accessory is connected to the connecting barrel component, the transmission input shaft of the transmission accessory obtains power from the secondary output shaft of the stand mixer, and drives the stirring shaft component to rotate in the temperature storage barrel assembly through the transmission output shaft.

In the above technical solution, the temperature storage barrel assembly comprises an outer barrel and an inner barrel arranged in sequence from outside to inside, and a temperature storage interlayer accommodated between the outer barrel and the inner barrel.

In the above technical solution, wherein the ice shaver accessory is provided with an ice shaver bevel gear set; and the ice shaver bevel gear set is coaxially sleeved on the shaver input shaft and the shaver output shaft, respectively, for transmission between the shaver input shaft and the shaver output shaft.

In the above technical solution, the ice shaver accessory is further provided with an ice shaver push shaft spring; one end portion of the ice shaver push shaft spring abuts against the ice shaver output shaft and/or the ice shaver bevel gear set at the ice shaver output shaft to apply an axial outward force to the ice shaver output shaft, thereby enabling the ice shaver output shaft to apply an axial force to the stirring shaft component.

In the above technical solution, a transmission bevel gear set is arranged in the transmission accessory; and the transmission bevel gear set is coaxially sleeved on the transmission input shaft and the transmission output shaft respectively, and is used for transmission between the transmission input shaft and the transmission output shaft.

In the above technical solution, the transmission accessory is further provided with a transmission push shaft spring; and one end portion of the transmission push shaft spring abuts against the transmission output shaft and/or the transmission bevel gear set at the transmission output shaft to apply an axial outward force to the transmission output shaft, thereby enabling the transmission output shaft to apply an axial force to the stirring shaft component.

In the above technical solution, first buckle claws are formed on a surface of the temperature storage barrel assembly; a first buckle groove is formed on a surface of the connecting barrel component; and the first buckle claws of the temperature storage barrel assembly are suitable for buckling at the first buckle groove of the connecting barrel component.

In the above technical solution, ice shaving pawls are formed on a surface of the ice shaver accessory; transmission pawls are formed on a surface of the transmission accessory; a second buckle groove is formed on a surface of the connecting barrel component; the ice shaving pawls of the ice shaver accessory are suitable for buckling into the second buckle groove of the connecting barrel component, and the transmission pawls of the transmission accessory are also suitable for buckling into the second buckle groove of the connecting barrel component.

In the above technical solution, a free end portion of the stirring shaft component is formed with a top-fitting portion; a bottom inner wall of the temperature storage barrel assembly is formed with a recessed portion; and the top-fitting portion of the stirring shaft component is suitable for abutting against the recessed portion of the temperature storage barrel assembly.

Compared with the prior art, beneficial effects of the present invention are as follows: in the stand mixer accessory for making ice cream of the present invention, when the ice shaver accessory is connected to the connecting barrel component, the ice shaver input shaft of the ice shaver accessory can obtain power from the secondary output shaft of the stand mixer, and drive the stirring shaft component to rotate in the temperature storage barrel assembly through the ice shaver output shaft; when the transmission accessory is connected to the connecting barrel component, the transmission input shaft of the transmission accessory can obtain power from the secondary output shaft of the stand mixer, and drive the stirring shaft component to rotate in the temperature storage barrel assembly through the transmission output shaft; in this way, the secondary output shaft of the stand mixer can be used to make ice cream without occupying the main output shaft of the stand mixer, and the stand mixer accessory for making ice cream of the present invention has the characteristics of being simple and easy to use, easy to disassemble, easy to clean, and being able to reuse the ice shaver accessory, thereby providing the stand mixer with an efficient and simple ice cream making device.

### BRIEF DESCRIPTION OF THE DRAWINGS

FIG. 1 is a three-dimensional view of the present invention when an ice shaver accessary is configured.

FIG. 2 is an exploded view of the present invention when the ice shaver accessary is configured.

FIG. 3 is a cross-sectional view of the present invention when the ice shaver accessary is configured.

FIG. 4 is a three-dimensional view of the present invention when a transmission accessary is configured.

FIG. 5 is an exploded view of the present invention when the transmission accessary is configured.

The markups in the drawings are indicated as follows:
11—temperature storage barrel assembly;
11—outer barrel;
111—first buckle claw;
12—inner barrel;
121—recessed portion;
13—temperature storage interlayer;
2—stirring shaft component;
21—top-fitting portion;
3—connecting barrel component;
31—first buckle groove;
32—second buckle groove;
4—ice shaver accessory;
41—ice shaver input shaft;
42—ice shaver output shaft;
43—ice shaving pawl;
44—ice shaver bevel gear set;
45—ice shaver push shaft spring;
5—transmission accessory;
51—transmission input shaft;
52—transmission output shaft;
53—transmission pawl; and
54—ice shaver push shaft spring.

### SPECIFIC EMBODIMENTS

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments of the present invention, all other embodiments obtained by ordinary technicians in this field without creative work are within the scope of protection of the present invention.

An embodiment provides a stand mixer accessory for making ice cream, which can be used in conjunction with the stand mixer (also known as a “food processor” or “cooking machine”) to utilize the power from a secondary output shaft of the stand mixer for ice cream production.

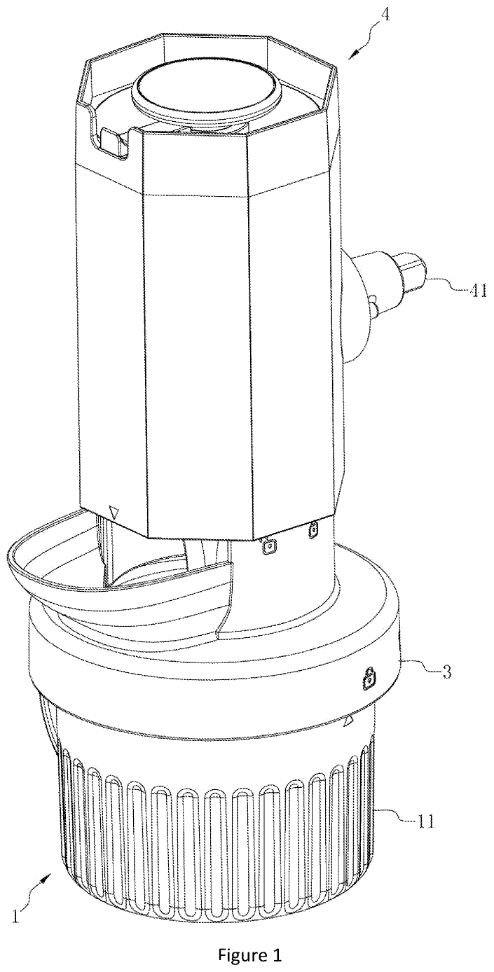

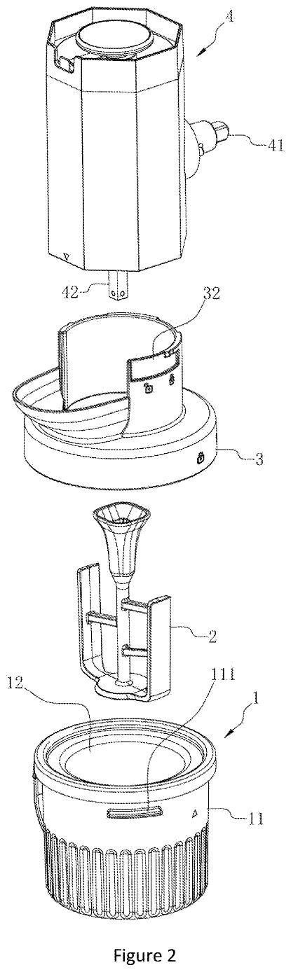

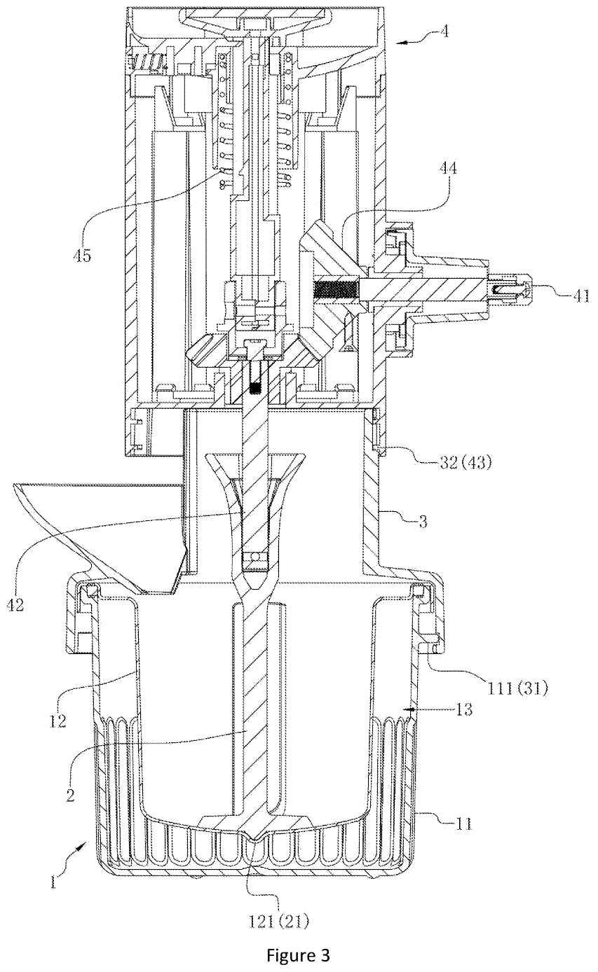

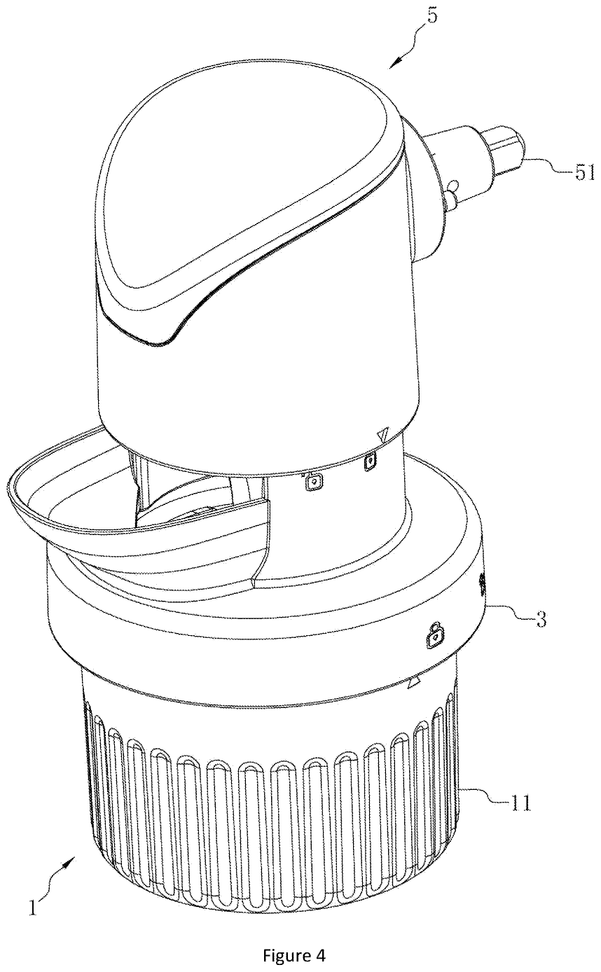

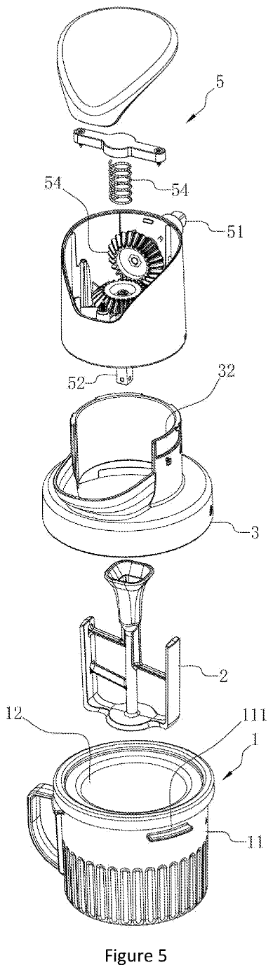

Please refer to FIGS. 1-5, the stand mixer accessory for making ice cream of the present embodiment comprises a temperature storage barrel assembly 1, a stirring shaft component 2, a connecting barrel component 3, an ice shaver accessory 4 and a transmission accessory 5.

The stirring shaft component 2 is a paddle-shaped work piece with a driven rotating shaft.

The ice shaver accessory 4 comprises an ice shaver input shaft 41 suitable for connecting to a secondary output shaft of a stand mixer, and an ice shaver output shaft 42 drivingly connected to the ice shaver input shaft 41.

The transmission accessory 5 comprises a transmission input shaft 51 suitable for connecting to the secondary output shaft of the stand mixer, and a transmission output shaft 52 drivingly connected to the transmission input shaft 51.

The connecting barrel component 3 covers the temperature storage barrel assembly 1, and the ice shaver accessory 4 and the transmission accessory 5 are connected to the connecting barrel component 3 interchangeably.

When the ice shaver accessory 4 is connected to the connecting barrel component 3, the ice shaver input shaft 41 of the ice shaver accessory 4 obtains power from the secondary output shaft of the stand mixer, and drives the stirring shaft component 2 to rotate in the temperature storage barrel assembly 1 through the ice shaver output shaft.

When the transmission accessory 5 is connected to the connecting barrel component 3, the transmission input shaft 51 of the transmission accessory 5 obtains power from the secondary output shaft of the stand mixer, and drives the stirring shaft component 2 to rotate in the temperature storage barrel assembly 1 through the transmission output shaft 52.

Specifically, the temperature storage barrel assembly 1 comprises an outer barrel 11 and an inner barrel 12 arranged in sequence from outside to inside, and a temperature storage interlayer 13 accommodated between the outer barrel 11 and the inner barrel 12, wherein the outer barrel 11 is a cylindrical body made of metal material, and the inner barrel 12 is a cylindrical body made of food-grade stainless steel or food-grade silicone material, both of which are fixed and sealed by upper edges, and the temperature storage interlayer 13 is made of a material with a higher specific heat capacity; in this way, after the temperature storage barrel assembly 1 is frozen, it can store a certain amount of cold, so that the liquid falling into the temperature storage barrel assembly 1 can be cooled until frost forms.

Specifically, the ice shaver accessory 4 is provided with an ice shaver bevel gear set 44; and the ice shaver bevel gear set 44 is coaxially sleeved on the shaver input shaft 41 and the shaver output shaft 42 (specifically, at an end portion of the ice shaver input shaft 41 and an end portion of the ice shaver output shaft 42), respectively, for transmitting between the ice shaver input shaft 41 and the ice shaver output shaft 42, and making the ice shaver input shaft 41 and the ice shaver output shaft 42 perpendicular to each other.

Further, the ice shaver accessory 4 is further provided with an ice shaver push shaft spring 45; one end portion of the ice shaver push shaft spring 45 abuts against the ice shaver output shaft 42 and/or the ice shaver bevel gear set 44 at the ice shaver output shaft 42, and another end portion of the ice shaver push shaft spring 45 abuts against an inner wall of the ice shaver accessory 4 or the fixed bracket in the ice shaver accessory 4 to apply an axial outward force to the ice shaver output shaft 42, so that the ice shaver output shaft 42 can apply an axial force to the stirring shaft component 2.

It is understandable that an ice cup structure, a push plate structure and an ice shaving blade structure of the ice shaver accessory 4 in the present embodiment have all been disassembled.

Specifically, a transmission bevel gear set is arranged in the transmission accessory 5; and the transmission bevel gear set is coaxially sleeved on the transmission input shaft 51 and the transmission output shaft 52 (specifically, at an end portion of the transmission input shaft 51 and an end portion of the transmission output shaft 52), and is used for transmitting between the transmission input shaft 51 and the transmission output shaft 52, and enables the transmission input shaft 51 and the transmission output shaft 52 to be perpendicular to each other.

Further, the transmission accessory 5 is further provided with a transmission push shaft spring 54; and one end portion of the transmission push shaft spring 54 abuts against the transmission output shaft 52 and/or the transmission bevel gear set at the transmission output shaft 52, and another end portion of the transmission push shaft spring 54 presses against an inner wall of the transmission accessory 5 or a fixed bracket in the transmission accessory 5 to apply an axial outward force to the transmission output shaft 52, so that the transmission output shaft 52 can apply an axial force to the stirring shaft component 2.

Specifically, first buckle claws 111 are formed on a surface of the temperature storage barrel assembly 1; in the present embodiment, the first buckle claws 111 are integrally formed on a top surface of the outer barrel 11 of the temperature storage barrel assembly 1; a first buckle groove 31 is formed on a surface of the connecting barrel component 3, and in the present embodiment, the first buckle groove 31 is integrally formed on an inner side of a bottom edge of the connecting barrel component 3; the first buckle claws 111 of the temperature storage barrel assembly 1 are suitable for buckling at the first buckle groove 31 of the connecting barrel component 3, so that the connecting barrel component 3 can cover the temperature storage barrel assembly 1.

Specifically, ice shaving pawls 43 are formed on a surface of the ice shaver accessory 4; and in the present embodiment, the ice shaving pawls 43 are integrally formed on an inner side of a bottom edge of the ice shaver accessory 4; transmission pawls 53 (not shown in the figures) are formed on a surface of the transmission accessory 5 and in the present embodiment, the transmission pawls 53 are integrally formed on an inner side of a bottom edge of the transmission accessory 5; a second buckle groove 32 is formed on a surface of the connecting barrel component 3 and in the present embodiment, the second buckle groove 32 is integrally formed on a top surface of the connecting barrel component 3; the ice shaving pawls 43 of the ice shaver accessory 4 are suitable for buckling into the second buckle groove 32 of the connecting barrel component 3, and the transmission pawls 53 of the transmission accessory 5 are also suitable for buckling into the second buckle groove 32 of the connecting barrel component 3; and in this way, the ice shaving accessory 4 and the transmission accessory 5 can be connected to the connecting barrel component 3 interchangeably.

Further, a free end portion of the stirring shaft component 2 is formed with a top-fitting portion 21. In fact, the top-fitting portion 21 is an arch-shaped structural feature integrally formed at the free end of the stirring shaft component 2; a recessed portion 121 is formed on a bottom inner wall of the temperature storage barrel assembly 1. In fact, the recessed portion 121 is a recessed structural feature integrally formed on a bottom inner wall of the inner barrel 12 of the temperature storage barrel assembly 1; the top-fitting portion 21 of the stirring shaft component 2 is suitable for abutting against the recessed portion 121 of the temperature storage barrel assembly 1 to position the stirring shaft component 2 and prevent the stirring shaft component 2 from dislocating.

When the stand mixer accessory for making ice cream of this embodiment is used, the temperature storage barrel assembly 1 is first frozen to store a certain amount of cold; then, the stirring shaft component 2 is installed in the temperature storage barrel assembly 1, and the connecting tube component 3 is covered on the temperature storage barrel assembly 1; one of the ice shaver accessory 4 or the transmission accessory 5 is selectively connected to the connecting tube component 3, at this time, the ice shaver output shaft 42 of the ice shaver accessory 4 is connected to the stirring shaft component 2 (the two are specially matched), and under the push of the ice shaver push shaft spring 45, an axial force is applied to the stirring shaft component 2, so that the top-fitting portion 21 of the stirring shaft component 2 is abutted against the recessed portion 121 of the temperature storage barrel assembly 1, or the transmission output shaft 52 of the transmission accessory 5 is connected to the stirring shaft component 2 (the two are specially matched), and under the push of the transmission push shaft spring 54, an axial force is applied to the stirring shaft component 2, so that the top-fitting portion 21 of the stirring shaft component 2 is abutted against the recessed portion 121 of the temperature storage barrel assembly 1; after the liquid for making ice cream is injected into the temperature storage barrel assembly 1 through the funnel of the connecting barrel component 3, the ice shaver input shaft 41 of the ice shaver accessory 4 is connected to the secondary output shaft of the stand mixer (usually a shaft hole that can provide power). After the secondary output shaft of the stand mixer is started, it can output power to the ice shaver input shaft 41 of the ice shaver accessory 4, and the power is transmitted to the ice shaver output shaft 42 via the ice shaver bevel gear set 44, so that the stirring shaft component 2 rotates to stir the liquid in the temperature storage barrel assembly 1, so that the liquid continuously adheres to the inner wall of the temperature storage barrel assembly 1 and exchanges heat with the temperature storage interlayer 13 of the temperature storage barrel assembly 1 until the liquid in the temperature storage barrel assembly 1 is frosted to form ice cream. Alternatively, the transmission input shaft 51 of the transmission accessory 5 is connected to the secondary output shaft of the stand mixer (usually a shaft hole that can provide power). After the secondary output shaft of the stand mixer is started, it can output power to the transmission input shaft 51 of the transmission accessory 5, and transmit the power to the transmission output shaft 52 via the transmission bevel gear set, so that the stirring shaft component 2 rotates to stir the liquid in the temperature storage barrel assembly 1, so that the liquid continuously adheres to the inner wall of the temperature storage barrel assembly 1 and exchanges heat with the temperature storage interlayer 13 of the temperature storage barrel assembly 1 until the liquid in the temperature storage barrel assembly 1 is frosted to form ice cream.

In the stand mixer accessory for making ice cream of the present embodiment, when the ice shaver accessory 4 is connected to the connecting barrel component 3, the ice shaver input shaft 41 of the ice shaver accessory 4 can obtain power from the secondary output shaft of the stand mixer, and drive the stirring shaft component 2 to rotate in the heat storage barrel assembly 1 through the ice shaver output shaft 42; when the transmission accessory 5 is connected to the connecting barrel component 3, the transmission input shaft 51 of the transmission accessory 5 can obtain power from the secondary output shaft of the stand mixer, and drive the stirring shaft component 2 to rotate in the heat storage barrel assembly 1 through the transmission output shaft 52; in this way, the secondary output shaft of the stand mixer can be used to make ice cream without occupying the main output shaft of the stand mixer, and the stand mixer accessory for making ice cream of the present embodiment has the characteristics of being simple and easy to use, easy to disassemble, easy to clean, and able to reuse the ice shaver accessory 4, providing an efficient and simple ice cream making device for stand mixers.

Although embodiments of the present invention have been shown and described, it will be appreciated by those skilled in the art that various changes, modifications, substitutions and variations may be made to the embodiments without departing from the principles and spirit of the present invention, and that the scope of the present invention is defined by the appended claims and their equivalents.

1. A stand mixer accessory for making ice cream, comprising a temperature storage barrel assembly, a stirring shaft component, a connecting barrel component, an ice shaver accessory and a transmission accessory, wherein
the ice shaver accessory comprises an ice shaver input shaft suitable for connecting to a secondary output shaft of a stand mixer, and an ice shaver output shaft drivingly connected to the ice shaver input shaft;
the transmission accessory comprises a transmission input shaft suitable for connecting to the secondary output shaft of the stand mixer, and a transmission output shaft drivingly connected to the transmission input shaft;
the connecting barrel component covers the temperature storage barrel assembly, and the ice shaver accessory and the transmission accessory are connected to the connecting barrel component interchangeably;
when the ice shaver accessory is connected to the connecting barrel component, the ice shaver input shaft of the ice shaver accessory obtains power from the secondary output shaft of the stand mixer, and drives the stirring shaft component to rotate in the temperature storage barrel assembly through the ice shaver output shaft; and
when the transmission accessory is connected to the connecting barrel component, the transmission input shaft of the transmission accessory obtains power from the secondary output shaft of the stand mixer, and drives the stirring shaft component to rotate in the temperature storage barrel assembly through the transmission output shaft.

2. The stand mixer accessory for making ice cream according to claim 1, wherein the temperature storage barrel assembly comprises an outer barrel and an inner barrel arranged in sequence from outside to inside, and a temperature storage interlayer accommodated between the outer barrel and the inner barrel.

3. The stand mixer accessory for making ice cream according to claim 1, wherein the ice shaver accessory is provided with an ice shaver bevel gear set; and
the ice shaver bevel gear set is coaxially sleeved on the shaver input shaft and the shaver output shaft, respectively, for transmission between the shaver input shaft and the shaver output shaft.

4. The stand mixer accessory for making ice cream according to claim 3, wherein the ice shaver accessory is further provided with an ice shaver push shaft spring;
one end portion of the ice shaver push shaft spring abuts against the ice shaver output shaft and/or the ice shaver bevel gear set at the ice shaver output shaft to apply an axial outward force to the ice shaver output shaft, thereby enabling the ice shaver output shaft to apply an axial force to the stirring shaft component.

5. The stand mixer accessory for making ice cream according to claim 1, wherein a transmission bevel gear set is arranged in the transmission accessory; and
the transmission bevel gear set is coaxially sleeved on the transmission input shaft and the transmission output shaft respectively, and is used for transmission between the transmission input shaft and the transmission output shaft.

6. The stand mixer accessory for making ice cream according to claim 5, wherein the transmission accessory is further provided with a transmission push shaft spring; and
one end portion of the transmission push shaft spring abuts against the transmission output shaft and/or the transmission bevel gear set at the transmission output shaft to apply an axial outward force to the transmission output shaft, thereby enabling the transmission output shaft to apply an axial force to the stirring shaft component.

7. The stand mixer accessory for making ice cream according to claim 1, wherein first buckle claws are formed on a surface of the temperature storage barrel assembly;
a first buckle groove is formed on a surface of the connecting barrel component; and
the first buckle claws of the temperature storage barrel assembly are suitable for buckling at the first buckle groove of the connecting barrel component.

8. The stand mixer accessory for making ice cream according to claim 1, wherein
ice shaving pawls are formed on a surface of the ice shaver accessory;
transmission pawls are formed on a surface of the transmission accessory;
a second buckle groove is formed on a surface of the connecting barrel component;
the ice shaving pawls of the ice shaver accessory are suitable for buckling into the second buckle groove of the connecting barrel component, and the transmission pawls of the transmission accessory are also suitable for buckling into the second buckle groove of the connecting barrel component.

9. The stand mixer accessory for making ice cream according to claim 1, wherein a free end portion of the stirring shaft component is formed with a top-fitting portion;
a bottom inner wall of the temperature storage barrel assembly is formed with a recessed portion; and
the top-fitting portion of the stirring shaft component is suitable for abutting against the recessed portion of the temperature storage barrel assembly.

10. The stand mixer accessory for making ice cream according to claim 2, wherein the ice shaver accessory is provided with an ice shaver bevel gear set; and
the ice shaver bevel gear set is coaxially sleeved on the shaver input shaft and the shaver output shaft, respectively, for transmission between the shaver input shaft and the shaver output shaft.

11. The stand mixer accessory for making ice cream according to claim 10, wherein the ice shaver accessory is further provided with an ice shaver push shaft spring;
one end portion of the ice shaver push shaft spring abuts against the ice shaver output shaft and/or the ice shaver bevel gear set at the ice shaver output shaft to apply an axial outward force to the ice shaver output shaft, thereby enabling the ice shaver output shaft to apply an axial force to the stirring shaft component.

12. The stand mixer accessory for making ice cream according to claim 2, wherein a transmission bevel gear set is arranged in the transmission accessory; and
the transmission bevel gear set is coaxially sleeved on the transmission input shaft and the transmission output shaft respectively, and is used for transmission between the transmission input shaft and the transmission output shaft.

13. The stand mixer accessory for making ice cream according to claim 12, wherein the transmission accessory is further provided with a transmission push shaft spring; and
one end portion of the transmission push shaft spring abuts against the transmission output shaft and/or the transmission bevel gear set at the transmission output shaft to apply an axial outward force to the transmission output shaft, thereby enabling the transmission output shaft to apply an axial force to the stirring shaft component.

14. The stand mixer accessory for making ice cream according to claim 7, wherein
ice shaving pawls are formed on a surface of the ice shaver accessory;
transmission pawls are formed on a surface of the transmission accessory;
a second buckle groove is formed on a surface of the connecting barrel component;
the ice shaving pawls of the ice shaver accessory are suitable for buckling into the second buckle groove of the connecting barrel component, and the transmission pawls of the transmission accessory are also suitable for buckling into the second buckle groove of the connecting barrel component.
